(19) United States
(12) Patent Application Publication
(10) Pub. No.: US 2025/0363497 A1
(43) Pub. Date: Nov. 27, 2025

(54) REMOTE CUSTOMER SERVICE SYSTEM, INFORMATION PROCESSING DEVICE, AND REMOTE CUSTOMER SERVICE METHOD

(71) Applicant: Hitachi, Ltd., Tokyo (JP)

(72) Inventors: Kenji FUJIHIRA, Tokyo (JP); Hideki SHIMOBAYASHI, Tokyo (JP)

(21) Appl. No.: 19/075,715

(22) Filed: Mar. 10, 2025

(30) Foreign Application Priority Data
May 21, 2024 (JP) 2024-082837

(51) Int. Cl. G06Q 30/015; G06T 7/70; G06V 20/52; G06V 40/10; H04N 7/18; H04N 23/90

(52) U.S. Cl. CPC G06Q 30/015; G06T 7/70; G06V 20/53; G06V 40/10; H04N 7/181; H04N 23/90; G06T 2207/30196; G06T 2207/30232; G06T 2207/30242

(57) ABSTRACT

A remote customer service system comprises: a server; and cameras that are placed in each of a plurality of shops and that are couplable to user terminals, the server: calculates, for each of the cameras, an index value based on a degree of congestion of customers and on the number of shop clerks included in the photographable area of the camera, the degree of congestion being based on the number of the physically visiting customers who are included in the photographable area of the camera and the number of user terminals that are coupled to the camera at present; and selects, based on the index value, one of the cameras that is to be coupled to the first user terminal, and remote communication is executed between the first user terminal and the selected one of the cameras.

### CLAIM OF PRIORITY

The present application claims priority from Japanese patent application JP 2024-082837 filed on May 21, 2024, the content of which is hereby incorporated by reference into this application.

### BACKGROUND OF THE INVENTION

The present invention is related to a remote customer service system, an information processing device, and a remote customer service method.

As the background art of a technical field of this invention, JP 2019-79269 A is given. This publication includes the following description (see Abstract): “A remote customer service program causes a computer to execute processing of receiving input or selection of information for identifying a commercial product and information for identifying a region in which the commercial product is planned to be used, from a terminal of a customer. The remote customer service program causes the computer to execute processing of identifying sales clerks who handle the commercial product and who are associated with the region. The remote customer service program also causes the computer to execute processing of holding communication between a terminal of a selected sales clerk and the terminal of the customer.”

The technology as described in JP 2019-79269 A enables a customer to be remotely attended to by matching the customer with a shop clerk, but, in such cases as when the matched shop clerk is being engaged with something and is unavailable at the moment, the customer cannot promptly be attended to remotely.

### SUMMARY OF THE INVENTION

Accordingly, in at least one aspect of this invention, remote customer service to attend to a user is promptly started. Thus, the at least one aspect of this invention accomplishes remote customer service that lessens troubles of customers and reduces losses of chances of sales.

The at least one aspect of this invention adopts the following structures in order to solve the above problem. A remote customer service system, comprises: a server; and one or more cameras that are placed in each of a plurality of shops and that are couplable to user terminals, the server is configured to: hold camera management information indicating the number of shop clerks included in a photographable area of each of the one or more cameras, the number of physically visiting customers in the photographable area, and the user terminals that are respectively coupled at present to the one or more cameras; receive a shop login request from a first user terminal; calculate, for each of the one or more cameras, an index value based on a degree of congestion of customers and on the number of shop clerks included in the photographable area, the degree of congestion being based on the number of the physically visiting customers who are included in the photographable area and the number of the user terminals that are coupled at present; and select, based on the index value, one of the one or more cameras that is to be coupled to the first user terminal, and remote communication is executed between the first user terminal and the selected one of the one or more cameras.

In at least the one aspect of this invention, remote customer service to attend to a user can be promptly started

Problems, configurations, and effects which are not mentioned above are explained in the following embodiments.

### BRIEF DESCRIPTION OF THE DRAWINGS

FIG. 1 is a block diagram for illustrating a configuration example of a remote customer service system according to the First Embodiment.

FIG. 2 is a block diagram for illustrating a configuration example of an XR (Extended Reality/Cross Reality) server according to the First Embodiment.

FIG. 3 is a block diagram for illustrating a configuration example of a shop server according to the First Embodiment.

FIG. 4A is an explanatory diagram for illustrating an example of a layout of a shop X in which a shop system is placed according to the First Embodiment.

FIG. 4B is an explanatory diagram for illustrating an example of a layout of a shop Y in which the shop system is placed according to the First Embodiment.

FIG. 4C is an explanatory diagram for illustrating an example of a layout of a shop Z in which the shop system is placed according to the First Embodiment.

FIG. 5 is a table for showing a data configuration example of a user management table according to the First Embodiment.

FIG. 6 is a table for showing a data configuration example of a shop clerk management table according to the First Embodiment.

FIG. 7 is a table for showing a data configuration example of a shop management table according to the First Embodiment.

FIG. 8A is a table for showing a data configuration example of a position information management table of the shop X according to the First Embodiment.

FIG. 8B is a table for showing a data configuration example of the position information management table of the shop Y according to the First Embodiment.

FIG. 8C is a table for showing a data configuration example of the position information management table of the shop Z according to the First Embodiment.

FIG. 9A is a table for showing a data configuration example of a camera management table of the shop X according to the First Embodiment.

FIG. 9B is a table for showing a data configuration example of the camera management table of the shop Y according to the First Embodiment.

FIG. 9C is a table for showing a data configuration example of the camera management table of the shop Z according to the First Embodiment.

FIG. 10A is a table for showing a data configuration example of a commercial item type management table of the shop X according to the First Embodiment.

FIG. 10B is a table for showing a data configuration example of the commercial item type management table of the shop Y according to the First Embodiment.

FIG. 10C is a table for showing a data configuration example of the commercial item type management table of the shop Z according to the First Embodiment.

FIG. 11A is a sequence diagram for illustrating an example of overall processing of the remote customer service system according to the First Embodiment.

FIG. 11B is a sequence diagram for illustrating an example of overall processing of the remote customer service system according to the First Embodiment.

FIG. 12 is a diagram for illustrating a screen configuration example of a shopping mall display screen according to the First Embodiment.

FIG. 13 is a flow chart for illustrating an example of user management processing according to the First Embodiment.

FIG. 14 is a flow chart for illustrating an example of shop selection processing according to the First Embodiment.

FIG. 15 is a flow chart for illustrating an example of customer service management processing according to the First Embodiment.

FIG. 16 is a flow chart for illustrating an example of camera management table update processing according to the First Embodiment.

### DETAILED DESCRIPTION OF THE PREFERRED EMBODIMENTS

In the following, embodiments of the present invention are explained referring the attached drawings. In the embodiments, the same configuration has the same reference letter, and repeated explanation are omitted. The embodiments are examples to achieve the present invention and do not limit a technical range of the present invention.

### First Embodiment

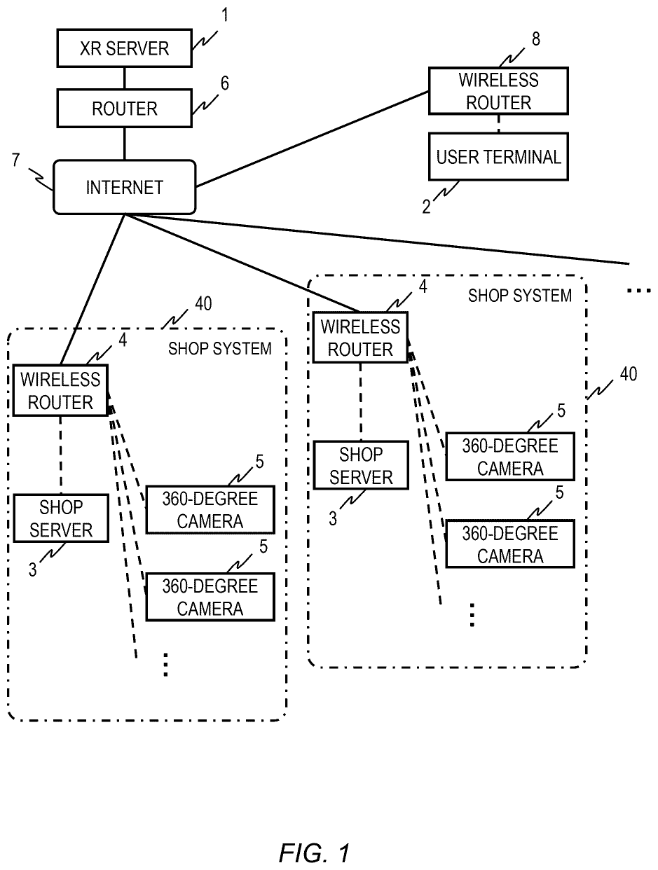

FIG. 1 is a block diagram for illustrating a configuration example of a remote customer service system. In this embodiment, a brand has a plurality of shops each of which is staffed with shop clerks. In this embodiment, each of the plurality of shops is further stocked with one or more commercial items. The shop clerks staffing each shop provide face-to-face customer service to physically visiting customers who visit the shop, and also provide remote customer service with use of the remote customer service system to users who are in remote places.

The remote customer service system includes, for example, an extended reality/cross reality (XR) server 1, one or more user terminals 2, and a plurality of shop systems 40. The XR server 1, each user terminal 2, and each of the shop systems 40 are coupled to Internet 7 via a router 6, a wireless router 8, and a wireless router 4 that is included in the shop system 40, respectively, to thereby hold two-way communication among the XR server 1, the one or more user terminals 2, and the plurality of shop systems 40. The method of communication among the XR server 1, the one or more user terminals 2, and the plurality of shop systems 40 is not limited to the example illustrated in FIG. 1.

The XR server 1 executes intermediary processing for implementing remote customer service provided by the shop clerks who staff shops at which the shop systems 40 are placed, to a user or users owning the one or more user terminals 2.

Each of the shop systems 40 is placed in a shop. The shop systems 40 each include a shop server 3, the wireless router 4, and one or more 360-degree cameras 5. In the example of FIG. 1, each 360-degree camera 5 is a network camera coupled to the wireless router 4, but may be a web camera coupled to the shop server 3. The one or more 360-degree cameras 5 may be replaced with one or more cameras each having a viewing field of less than 360 degrees.

A microphone and a speaker are mounted (or coupled) to each 360-degree camera 5. Each shop server 3 transmits video and audio acquired by each 360-degree camera 5 to the relevant user terminal 2, and outputs, from the relevant 360-degree camera 5, audio received from the relevant user terminal 2, to thereby implement remote customer service between the user who owns the relevant user terminal 2 and one of the shop clerks present at the shop in which the one of the shop systems 40 is placed.

The one or more user terminals 2 may be, for example, personal computers (PCs), smartphones, tablet terminals, or the like in which an application for implementing predetermined functions in a virtual space or at a shop logged into is installed, or may be a headset (for example, a virtual reality (VR) headset) including a goggle-type display device, a headphone, a microphone, and a gyroscope sensor.

The application implements functions for enabling the user to, for example, enter a virtual space of a shopping mall described later or a logged-in shop, travel inside the virtual space or the logged-in shop, view objects placed inside the virtual space or the logged-in shop, and communicate with the shop clerks staffing the logged-in shop. Traveling inside the logged-in shop is implemented by, for example, selecting another 360-degree camera 5 out of the 360-degree cameras 5 that are displayed on a display device of the user terminal 2, in accordance with input from the user of the user terminal 2, and transmitting a coupling request for switching the 360-degree camera 5 that is a coupling destination to the another 360-degree camera 5 to the shop server 3. This enables the user to freely and easily travel from one point at which the user wants to take a look around to another point as the user tours the logged-in shop.

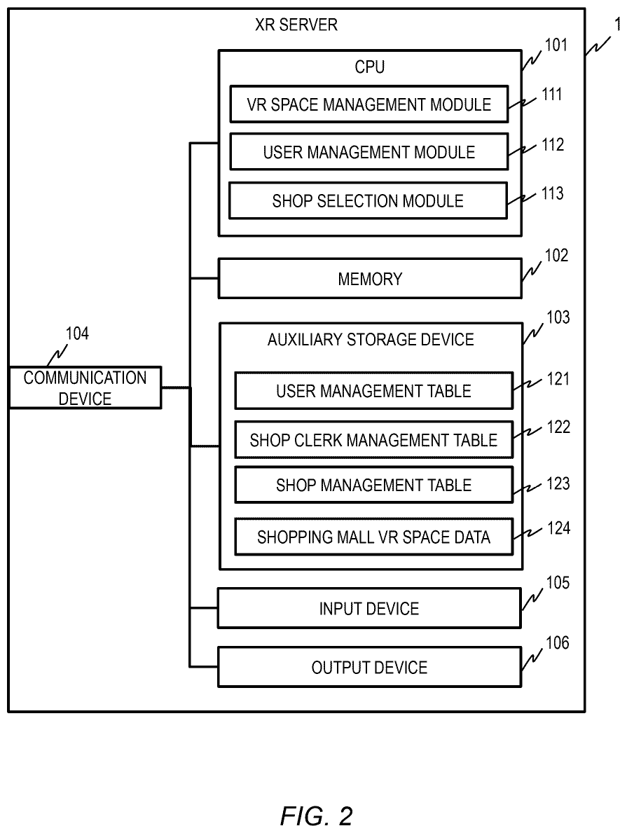

FIG. 2 is a block diagram for illustrating a configuration example of the XR server 1. The XR server 1 is configured from, for example, a computer including a central processing unit (CPU) 101, a memory 102, an auxiliary storage device 103, a communication device 104, an input device 105, and an output device 106.

The CPU 101 is an example of a processor, and executes a program stored in the memory 102. The memory 102 includes a read-only memory (ROM) which is a non-volatile storage element and a random access memory (RAM) which is a volatile storage element. The ROM stores, among others, an unchanging program (for example, a Basic Input/Output System: BIOS). The RAM is a storage element that is high-speed and volatile, such as a dynamic random access memory (DRAM), and temporarily stores programs executed by the CPU 101 and data used in the execution of each of the programs.

The auxiliary storage device 103 is a storage device that has a large capacity and is non-volatile, for example, a magnetic storage device (hard disk drive: HDD) or a flash memory (solid state drive: SSD), and stores programs executed by the CPU 101 and data used in the execution of each of the programs. Specifically, the program is read out of the auxiliary storage device 103, and is then loaded onto the memory 102 to be executed by the CPU 101.

The input device 105 is a device that receives input from an operator, such as a keyboard and a mouse. The output device 106 is a device that outputs a result of executing a program in a format visually recognizable to the operator, such as a display device and a printer.

The communication device 104 is a network interface device which follows a predetermined protocol to control communication to and from another device. The communication device 104 may include a serial interface, for example, a universal serial bus (USB).

Some or all of programs executed by the CPU 101 may be provided to the XR server 1 via a network from a removable medium (a CD-ROM, a flash memory, or the like) which is a non-transitory storage medium, or via an external computer including a non-transitory storage device, to be stored on the non-volatile auxiliary storage device 103 which is a non-transitory storage medium. It is accordingly recommended for the XR server 1 to include an interface for reading data out of a removable medium. The same applies to each of the user terminal 2 and the shop server 3.

The XR server 1 is a computer system configured physically on a single computer, or on a plurality of logically or physically configured computers, and may run in separate threads on the same computer, or run on a virtual computer built on a plurality of physical computer resources. The same applies to each of the user terminal 2 and the shop server 3.

The CPU 101 includes, for example, a VR space management module 111, a user management module 112, and a shop selection module 113 which are each a function module. The VR space management module 111 manages a VR space displayed on the one or more user terminals 2. The user management module 112 manages information about the user(s) of the one or more user terminals 2. The shop selection module 113 selects, for each user terminal 2, the 360-degree camera 5 to which the user terminal 2 is to be coupled from the one or more 360-degree cameras 5 installed at the shops.

For example, the CPU 101 functions as the VR space management module 111 by operating in accordance with a VR space management program loaded onto the memory 102, functions as the user management module 112 by operating in accordance with a user management program loaded onto the memory 102, and functions as the shop selection module 113 by operating in accordance with a shop selection program loaded onto the memory 102. The same relationship between a program and a function module applies to function modules described later as modules included in an after-mentioned CPU 301 of the shop server 3.

Some or all of functions provided by the function modules in this embodiment may be implemented by hardware, for example, an application-specific integrated circuit (ASIC) or a field-programmable gate array (FPGA).

The auxiliary storage device 103 holds, for example, a user management table 121, a shop clerk management table 122, a shop management table 123, and shopping mall VR space data 124. The user management table 121 indicates information about the user of each user terminal 2. The shop clerk management table 122 indicates information about shop clerks staffing shops. The shop management table 123 indicates information about shops. The shopping mall VR space data 124 includes data for displaying the shopping mall as a VR space.

Some or all of pieces of information stored in the auxiliary storage device 103 and an after-mentioned auxiliary storage device 303 of the shop server 3 may be stored in the memory 102 and an after-mentioned memory 302, respectively, or may be stored in an external database.

In this embodiment, information used by the remote customer service system is not dependent on data structure, and may be expressed in any data structure. For example, a data structure appropriately selected from a table, a list, a database, and a queue may store the information.

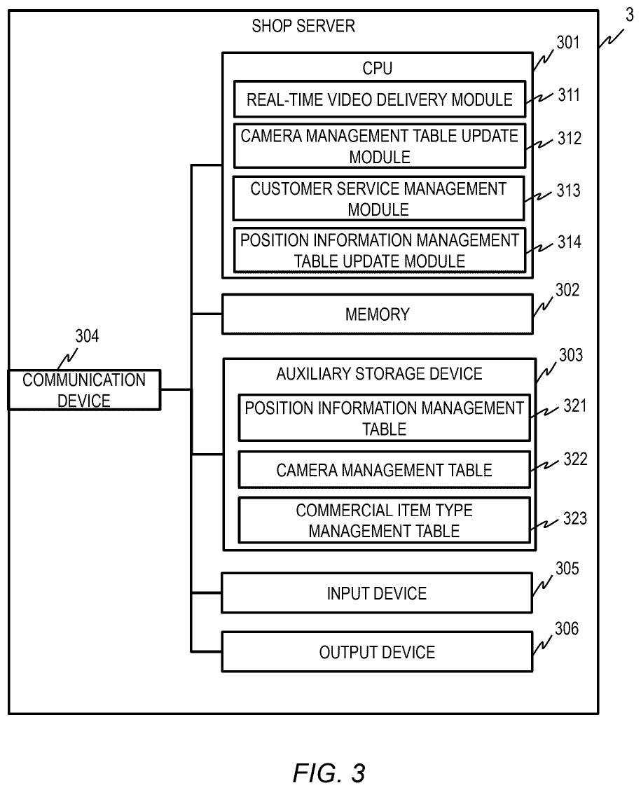

FIG. 3 is a block diagram for illustrating a configuration example of the shop server 3. The shop server 3 is configured from, for example, a computer including the CPU 301, the memory 302, the auxiliary storage device 303, a communication device 304, an input device 305, and an output device 306. Descriptions of the CPU 301, the memory 302, the auxiliary storage device 303, the communication device 304, the input device 305, and the output device 306 as hardware are the same as the descriptions of the CPU 101, the memory 102, the auxiliary storage device 103, the communication device 104, the input device 105, and the output device 106 as hardware, and are accordingly omitted.

The CPU 301 includes, for example, a real-time video delivery module 311, a camera management table update module 312, a customer service management module 313, and a position information management table update module 314, which are each a function module. The real-time video delivery module 311 delivers, for each 360-degree camera 5, video and audio acquired by the 360-degree camera 5 to the relevant user terminal 2. The camera management table update module 312 updates a camera management table 322 described later. The customer service management module 313 manages, for each user terminal 2, information about remote customer service provided to the user of the user terminal 2 by a shop clerk of a shop at which the 360-degree camera 5 that is coupled to the user terminal 2 is installed. The position information management table update module 314 updates a position information management table 321 described later.

The auxiliary storage device 303 holds, for example, the position information management table 321, the camera management table 322, and a commercial item type management table 323. The position information management table 321 holds information indicating positions of the one or more 360-degree cameras 5, shop clerks, and physically visiting customers in a shop. The camera management table 322 holds, for each 360-degree camera 5, information indicating a photographable area of the 360-degree camera 5, information indicating the number of shop clerks and the number of physically visiting customers in the photographable area, and information indicating a user ID of the user terminal 2 that is coupled to the 360-degree camera 5. The commercial item type management table 323 holds information indicating a commercial item with which a shop is stocked, and the 360-degree camera 5 that can photograph the commercial item.

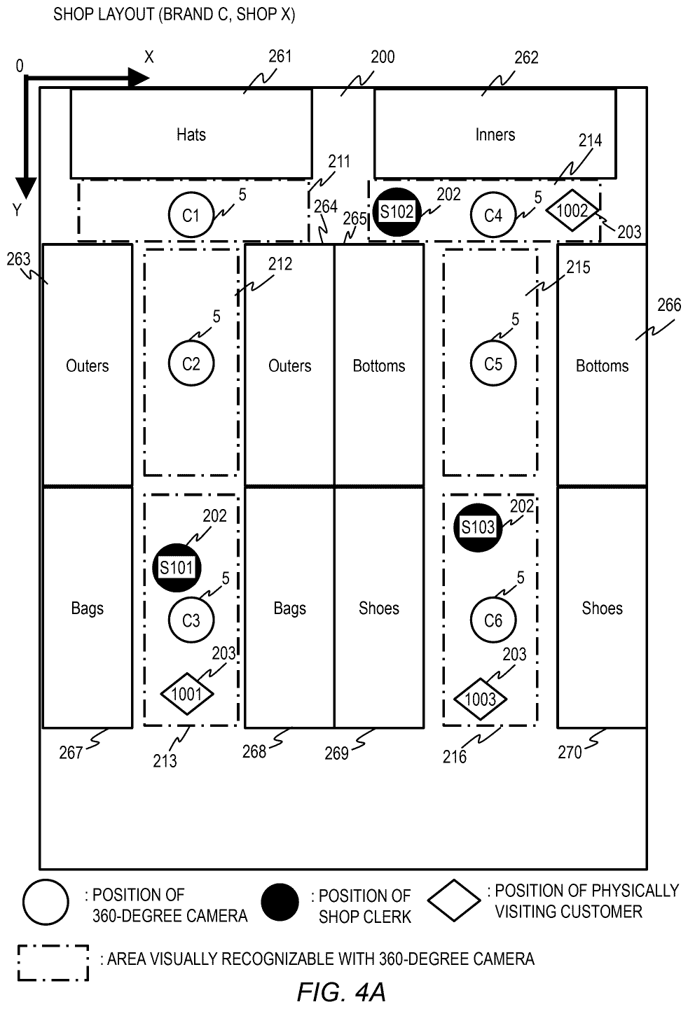

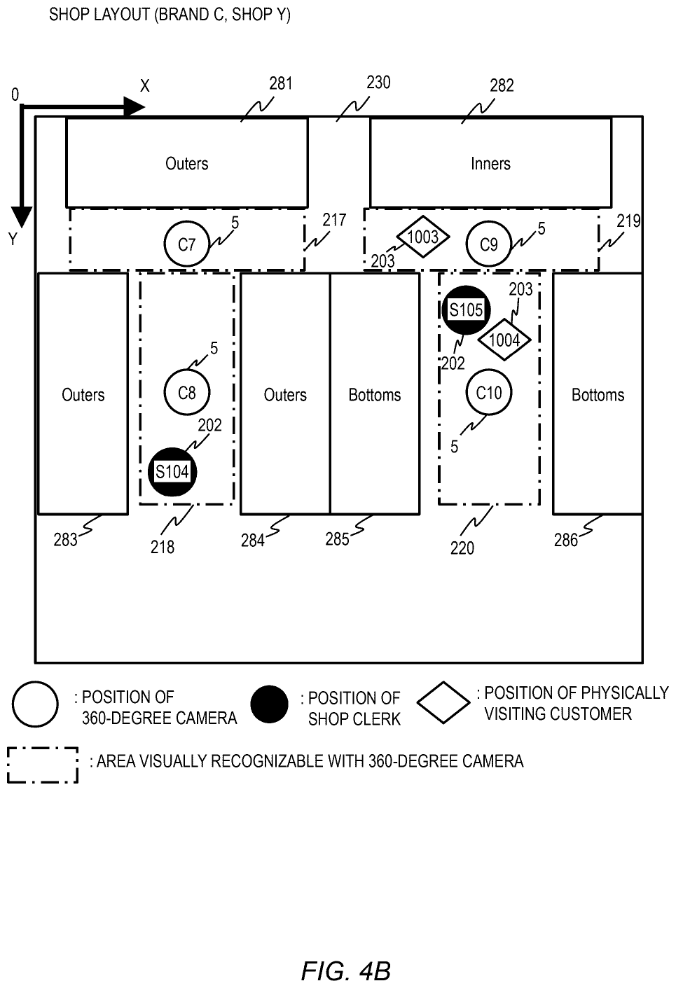

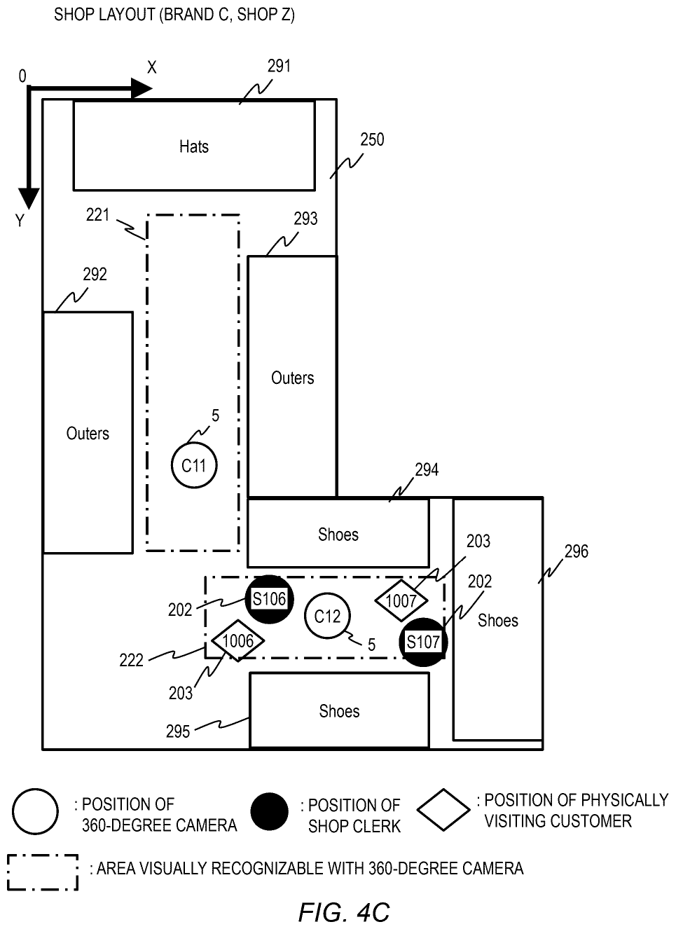

FIG. 4A, FIG. 4B, and FIG. 4C are each an explanatory diagram for illustrating an example of a layout of a shop in which one of the shop systems 40 is placed. FIG. 4A is an illustration of the layout of a shop X of a brand C, FIG. 4B is an illustration of the layout of a shop Y of the brand C, and FIG. 4C is an illustration of the layout of a shop Z of the brand C.

In FIG. 4A, FIG. 4B, and FIG. 4C, positions of the 360-degree cameras 5 are indicated by white circles, positions of shop clerks 202 are indicated by circles painted black, and positions of physically visiting customers 203 (customers who have actually come to visit the shops) are indicated by diamond-shaped marks. In FIG. 4A, FIG. 4B, and FIG. 4C, a letter string that is written inside each white circle representing one of the 360-degree cameras 5, a letter string that is written inside each black circle representing one of the shop clerks 202, and a letter string that is written inside each diamond-shaped mark representing one of the physically visiting customers 203 indicate a camera ID for identifying the 360-degree camera 5, a shop clerk ID for identifying the shop clerk 202, and a physically visiting customer ID for identifying the physically visiting customer 203, respectively.

Shelves 261 to 270 are installed on a floor 200 of the shop X illustrated in FIG. 4A. In FIG. 4A, FIG. 4B, and FIG. 4C, a letter string written inside each of the shelves 261 to 270, each of shelves 281 to 286, and each of shelves 291 to 296 indicates a commercial item displayed on the relevant shelf.

Six 360-degree cameras 5 are also installed on the floor 200, and have camera IDs “C1,” “C2,” “C3,” “C4,” “C5,” and “C6.” An area 211, an area 212, an area 213, an area 214, an area 215, and an area 216 on the floor 200 are photographable areas that can be photographed by the 360-degree cameras 5 associated with the camera IDs “C1,” “C2,” “C3,” “C4,” “C5,” and “C6,” respectively.

Accordingly, each user terminal 2 can display the shelf 261 when coupled to the 360-degree camera 5 of “C1,” display the shelf 263 and the shelf 264 when coupled to the 360-degree camera 5 of “C2,” display the shelf 267 and the shelf 268 when coupled to the 360-degree camera 5 of “C3,” display the shelf 262 when coupled to the 360-degree camera 5 of “C4,” display the shelf 265 and the shelf 266 when coupled to the 360-degree camera 5 of “C5,” and display the shelf 269 and the shelf 270 when coupled to the 360-degree camera 5 of “C6.”

In the area 211, the area 212, and the area 215, there are no shop clerks 202 and, consequently, it is highly likely that no shop clerks 202 notice audio that is received from the user terminal 2 coupled to the 360-degree camera 5 of “C1,” “C2,” or “C5” and that is output from the coupled 360-degree camera 5. When no shop clerks 202 notice the audio, the user cannot receive remote customer service. In each of the area 213, the area 214, and the area 216, there are one of the shop clerks 202 and one of the physically visiting customers 203, and the shop clerk 202 may be in the middle of attending to the physically visiting customer 203. Consequently, there is a possibility that the user of the user terminal 2 coupled to the 360-degree camera 5 of “C3,” “C4,” or “C6” cannot receive remote customer service.

Shelves 281 to 286 are installed on a floor 230 of the shop Y illustrated in FIG. 4B. Four 360-degree cameras 5 are also installed on the floor 230, and have camera IDs “C7,” “C8,” “C9,” and “C10.” An area 217, an area 218, an area 219, and an area 220 on the floor 230 are photographable areas that can be photographed by the 360-degree cameras 5 associated with the camera IDs “C7,” “C8,” “C9,” and “C10,” respectively.

Accordingly, each user terminal 2 can display the shelf 281 when coupled to the 360-degree camera 5 of “C7,” display the shelf 283 and the shelf 284 when coupled to the 360-degree camera 5 of “C8,” display the shelf 282 when coupled to the 360-degree camera 5 of “C9,” and display the shelf 285 and the shelf 286 when coupled to the 360-degree camera 5 of “C10.”

In the area 217 and the area 219, there are no shop clerks 202 and, consequently, it is highly likely that no shop clerks 202 notice audio that is received from the user terminal 2 coupled to the 360-degree camera 5 of “C7” or “C9” and that is output from the coupled 360-degree camera 5. When no shop clerks 202 notice the audio, the user cannot receive remote customer service. In the area 220, there are one of the shop clerks 202 and one of the physically visiting customers 203, and the shop clerk 202 may be in the middle of attending to the physically visiting customer 203. Consequently, there is a possibility that the user of the user terminal 2 coupled to the 360-degree camera 5 of “C10” cannot receive remote customer service. In the area 218, one of the shop clerks 202 is present but there are no physically visiting customers 203. In other words, the shop clerk 202 is not attending to a customer and, accordingly, the user of the user terminal 2 coupled to the 360-degree camera 5 of “C8” can receive remote customer service.

Shelves 291 to 296 are installed on a floor 250 of the shop Z illustrated in FIG. 4C. Two 360-degree cameras 5 are also installed on the floor 250, and have camera IDs “C11” and “C12.” An area 221 and an area 222 on the floor 250 are photographable areas that can be photographed by the 360-degree cameras 5 associated with the camera IDs “C11” and “C12,” respectively.

Accordingly, each user terminal 2 can display the shelf 291, the shelf 292, and the shelf 293 when coupled to the 360-degree camera 5 of “C11,” and display the shelf 294, the shelf 295, and the shelf 296 when coupled to the 360-degree camera 5 of “C12.”

In the area 221, there are no shop clerks 202 and, consequently, it is highly likely that no shop clerks 202 notice audio that is received from the user terminal 2 coupled to the 360-degree camera 5 of “C11” and that is output from the coupled 360-degree camera 5. When no shop clerks 202 notice the audio, the user cannot receive remote customer service. In the area 222, there are two of the shop clerks 202 and two of the physically visiting customers 203, and the two shop clerks 202 may be each in the middle of attending to the relevant physically visiting customer 203. Consequently, there is a possibility that the user of the user terminal 2 coupled to the 360-degree camera 5 of “C12” cannot receive remote customer service.

The remote customer service system of this embodiment selects, for each user terminal 2, to which 360-degree camera 5 the user terminal 2 is to be coupled, based on, among other factors, the number of shop clerks 202 included in the photographable area of each 360-degree camera 5. Accordingly, as in the case of one of the shop clerks 202 who has a shop clerk ID “S106,” a shop clerk who is at a position close to the 360-degree camera 5 of “C11” but is outside the area 221 which is the photographable area of the 360-degree camera 5 of “C11” is not treated as a shop clerk available for remote customer service that uses the 360-degree camera 5.

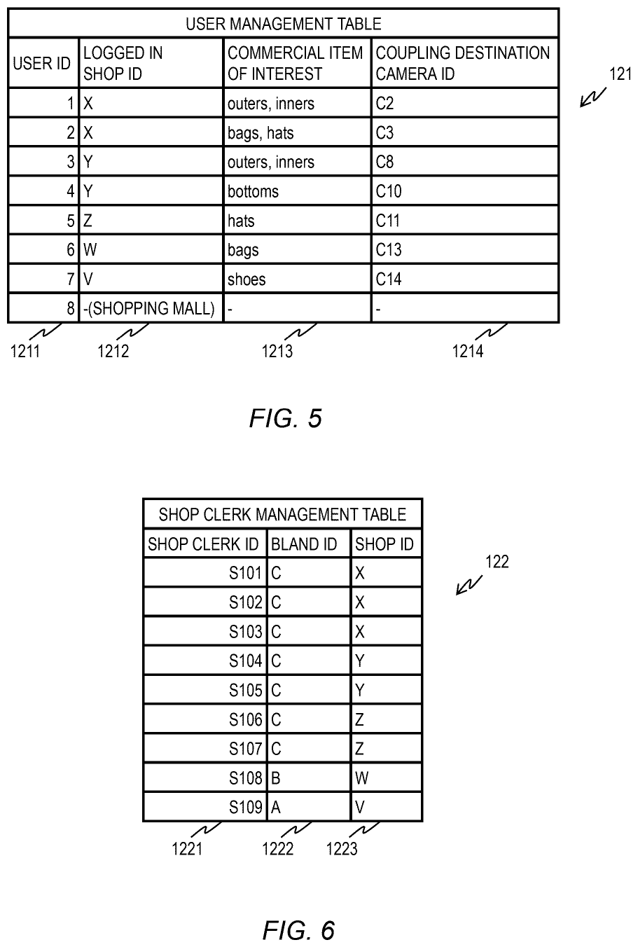

FIG. 5 is a table for showing a data configuration example of the user management table 121. The user management table 121 includes, for example, a user ID field 1211, a logged-in shop ID field 1212, a commercial-item-of-interest field 1213, and a coupling destination camera ID field 1214.

The user ID field 1211 holds a user ID for identifying a user. The logged-in shop ID field 1212 holds a shop ID (information for identifying a shop) of a shop to which the user is currently logged in. The commercial-item-of-interest field 1213 holds information indicating a commercial item in which the user is interested. The coupling destination camera ID field 1214 holds a camera ID (information for identifying a 360-degree camera) of a 360-degree camera to which the user terminal 2 used by the user is currently coupled.

FIG. 6 is a table for showing a data configuration example of the shop clerk management table 122. The shop clerk management table 122 includes, for example, a shop clerk ID field 1221, a brand ID field 1222, and a shop ID field 1223. A shop clerk ID indicated in the shop clerk ID field 1221 is a shop clerk ID of a shop clerk who is currently at work at a shop that belongs to a brand indicated by a brand ID (information for identifying a brand) associated with the shop clerk ID and that is indicated by a shop ID associated with the shop clerk ID.

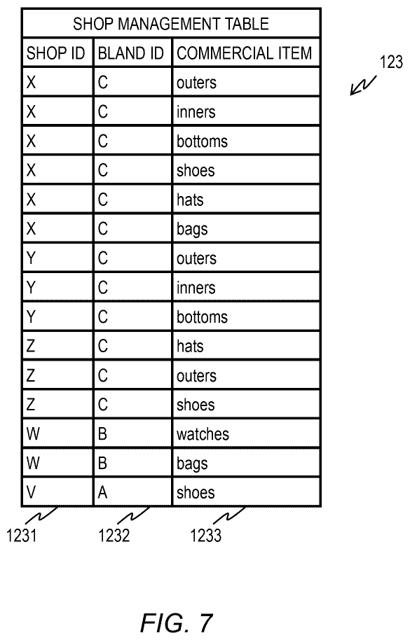

FIG. 7 is a table for showing a data configuration example of the shop management table 123. The shop management table 123 includes, for example, a shop ID field 1231, a brand ID field 1232, and a commercial item field 1233. A commercial item indicated in the commercial item field 1233 is a commercial item carried at a shop that belongs to a brand indicated by an associated brand ID and that is indicated by an associated shop ID.

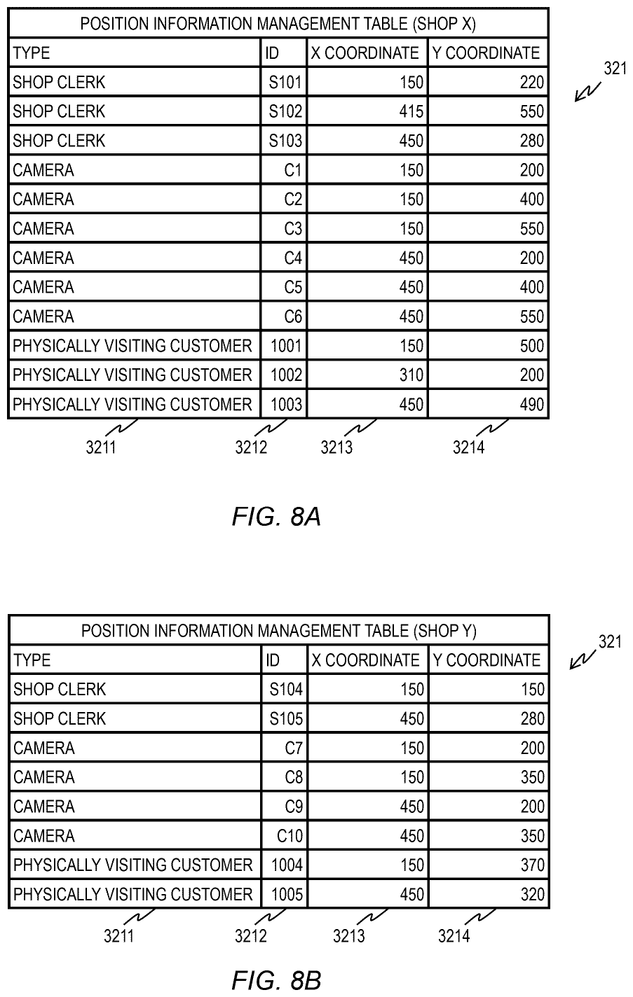

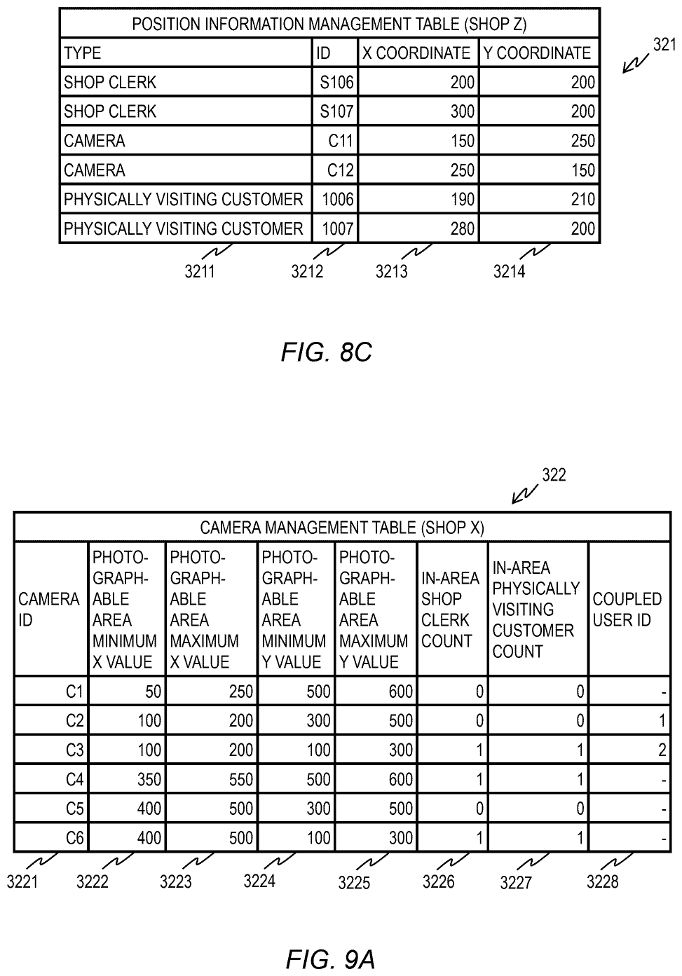

FIG. 8A, FIG. 8B, and FIG. 8C are each a table for showing a data configuration example of the position information management table 321. FIG. 8A is an illustration of the position information management table 321 of the shop X (that is, the position information management table 321 held by the shop server 3 that is installed at the shop X), FIG. 8B is an illustration of the position information management table 321 of the shop Y (that is, the position information management table 321 held by the shop server 3 that is installed at the shop Y), and FIG. 8C is an illustration of the position information management table 321 of the shop Z (that is, the position information management table 321 held by the shop server 3 that is installed at the shop Z).

The position information management table 321 includes, for example, a type field 3211, an ID field 3212, an X-coordinate field 3213, and a Y-coordinate field 3214. The type field 3211 holds information indicating a type of a target of which a position is indicated. Examples of the type include “shop clerk,” “camera,” and “physically visiting customer.” The ID field 3212 holds information indicating an ID of the target of which the position is indicated. A record that has “shop clerk” as the type holds a shop clerk ID in the ID field 3212, a record that has “camera” as the type holds a camera ID in the ID field 3212, and a record that has “physically visiting customer” as the type holds a physically visiting customer ID in the ID field 3212. The X-coordinate field 3213 and the Y-coordinate field 3214 hold values of an X-coordinate and a Y-coordinate, respectively, of the position of the target.

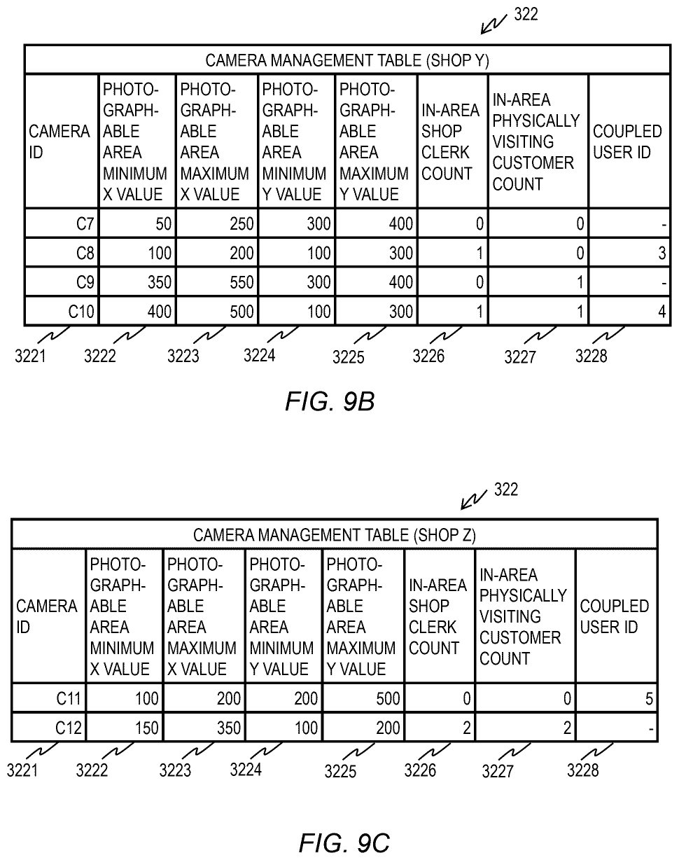

FIG. 9A, FIG. 9B, and FIG. 9C are each a table for showing a data configuration example of the camera management table 322. FIG. 9A is an illustration of the camera management table 322 of the shop X (that is, the camera management table 322 held by the shop server 3 that is installed at the shop X), FIG. 9B is an illustration of the camera management table 322 of the shop Y (that is, the camera management table 322 held by the shop server 3 that is installed at the shop Y), and FIG. 9C is an illustration of the camera management table 322 of the shop Z (that is, the camera management table 322 held by the shop server 3 that is installed at the shop Z).

The camera management table 322 includes, for example, a camera ID field 3221, a photographable area minimum X value field 3222, a photographable area maximum X value field 3223, a photographable area minimum Y value field 3224, a photographable area maximum Y value field 3225, an in-area shop clerk count field 3226, an in-area physically visiting customer count field 3227, and a coupled user ID field 3228.

The camera ID field 3221 holds a camera ID of a camera placed at the shop. The photographable area minimum X value field 3222, the photographable area maximum X value field 3223, the photographable area minimum Y value field 3224, and the photographable area maximum Y value field 3225 indicate a minimum value of X-coordinates, a maximum value of X-coordinates, a minimum value of Y-coordinates, and a maximum value of Y-coordinates, respectively, of a photographable area that can be photographed by the 360-degree camera 5 having an associated camera ID. In FIG. 9A to FIG. 9C and in FIG. 4A to FIG. 4C described above, a shape of the photographable area of each 360-degree camera 5 is rectangular, but the shape is not limited to a rectangle.

The in-area shop clerk count field 3226 holds information indicating the number of shop clerks present in the photographable area of the 360-degree camera 5 that has an associated camera ID. The in-area physically visiting customer count field 3227 holds information indicating the number of physically visiting customers present in the photographable area of the 360-degree camera 5 that has the associated camera ID. The coupled user ID field 3228 holds the user ID of a user who uses the user terminal 2 coupled to the 360-degree camera 5 that has the associated camera ID.

In the camera management table 322, an in-area shop clerk density and an in-area physically visiting customer density may be stored in place of, or in addition to, the in-area shop clerk count and the in-area physically visiting customer count. The in-area shop clerk density is the number of shop clerks present in the photographable area of the 360-degree camera 5 that has the associated camera ID, per unit area, and the in-area physically visiting customer density is the number of physically visiting customers present in the photographable area of the 360-degree camera 5 that has the associated camera ID, per unit area. In this case, it is recommended to use the in-area shop clerk density and the in-area physically visiting customer density in processing described later (for example, calculation of R in Step 824 described later), in place of the in-area shop clerk count and the in-area physically visiting customer count. In this embodiment, an example in which only one user terminal 2 can be coupled to one 360-degree camera 5 at a time is described.

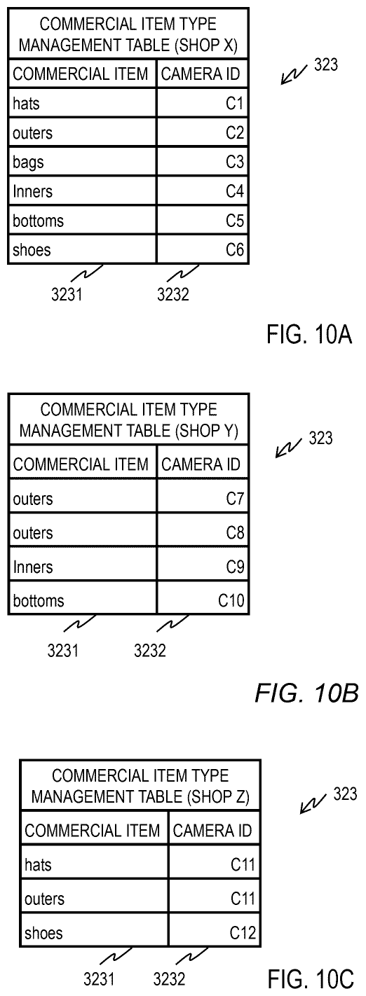

FIG. 10A, FIG. 10B, and FIG. 10C are each a table for showing a data configuration example of the commercial item type management table 323. FIG. 10A is an illustration of the commercial item type management table 323 of the shop X (that is, the commercial item type management table 323 held by the shop server 3 that is installed at the shop X), FIG. 10B is an illustration of the commercial item type management table 323 of the shop Y (that is, the commercial item type management table 323 held by the shop server 3 that is installed at the shop Y), and FIG. 10C is an illustration of the commercial item type management table 323 of the shop Z (that is, the commercial item type management table 323 held by the shop server 3 that is installed at the shop Z).

The commercial item type management table 323 includes, for example, a commercial item field 3231 and a camera ID field 3232. A commercial item that can be photographed in the shop by the 360-degree camera 5 having a camera ID indicated in the camera ID field 3232 is indicated in the commercial item field 3231.

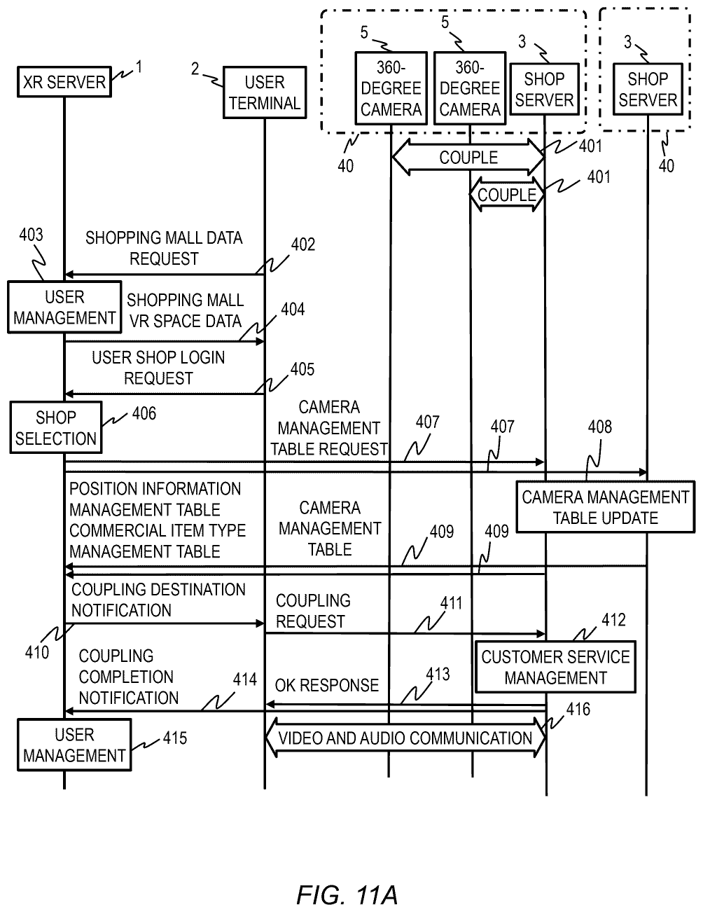

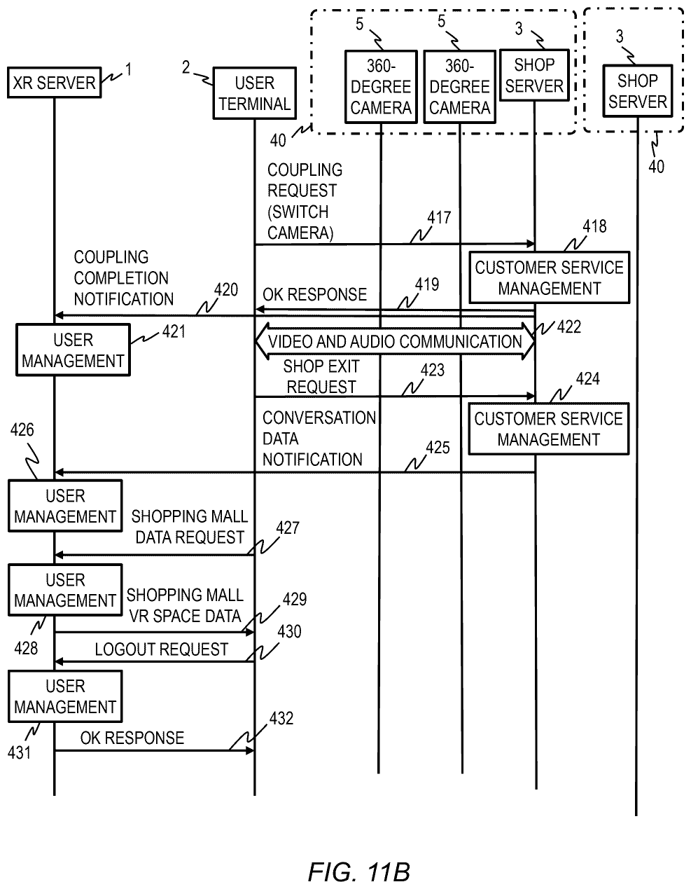

FIG. 11A and FIG. 11B are each a sequence diagram for illustrating an example of overall processing of the remote customer service system. For example, processing of FIG. 11B is executed subsequently to processing of FIG. 11A. In the examples of FIG. 11A and FIG. 11B, two shop systems 40 are illustrated (that is, an example in which there are two shops is illustrated), but there may be three or more shop systems 40. Although all shop systems 40 include the 360-degree cameras 5, in the examples of FIG. 11A and FIG. 11B, an illustration of 360-degree cameras included in one of the shop systems 40 is omitted due to space limitation of the drawings.

Before the processing of FIG. 11A and the processing of FIG. 11B are started, values are set in advance in the tables held by the XR server 1, specifically, values in the user ID field 1211 and the commercial-item-of-interest field 1213 of the user management table 121, values in the respective fields of the shop clerk management table 122, and values in the respective fields of the shop management table 123. Before the processing of FIG. 11A and the processing of FIG. 11B are started, values are set in advance in the tables held by each shop server 3, specifically, values in the respective fields of each record of the position information management table 321 that has “camera” as the value in the type field 3211, values in the camera ID field 3221, the photographable area minimum X value field 3222, the photographable area maximum X value field 3223, the photographable area minimum Y value field 3224, and the photographable area maximum Y value field 3225 of the camera management table 322, and values in the respective fields of the commercial item type management table 323.

Values in the respective fields of each record of the position information management table 321 that has “shop clerk” as the value in the type field 3211 and each record of the position information management table 321 that has “physically visiting customer” as the value in the type field 3211 are kept updated by the position information management table update module 314. Specifically, for example, a sensor for detecting a flow of people such as a Light Detection and Ranging (LiDAR) sensor is placed at each shop, and the position information management table update module 314 keeps receiving and analyzing information of the sensor, to thereby identify positions of shop clerks and physically visiting customers. For example, the information of the sensor can be used to identify a person who enters or exits a certain area (for example, a backroom) of the shop as a shop clerk and a person who does not enter or exit the certain area as a physically visiting customer. How the positions of shop clerks and physically visiting customers are identified is not limited to this method.

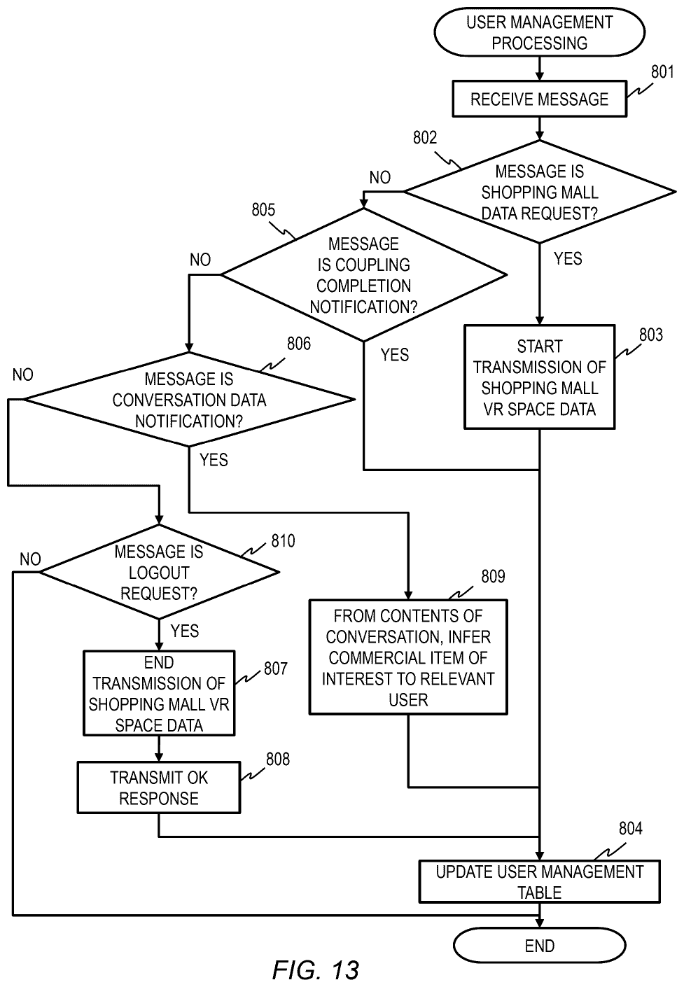

Each 360-degree camera 5 couples itself to the shop server 3 included in one of the shop systems 40 that includes the 360-degree camera 5 (401). In accordance with input from a user, the user terminal 2 of the user transmits a shopping mall data request to the XR server 1 (402). When the shopping mall data request is received, the user management module 112 of the XR server 1 executes user management processing (403) and, in the user management processing, transmits the shopping mall VR space data 124 to the user terminal 2 that has transmitted the shopping mall data request (404). Details of the user management processing are described later with reference to FIG. 13. Step 404 completes entrance of the user of the user terminal 2 to a shopping mall which is a virtual space, and the VR space management module 111 follows an instruction from the user terminal 2 used by the user who has entered the shopping mall to control display contents and the like on the user terminal 2.

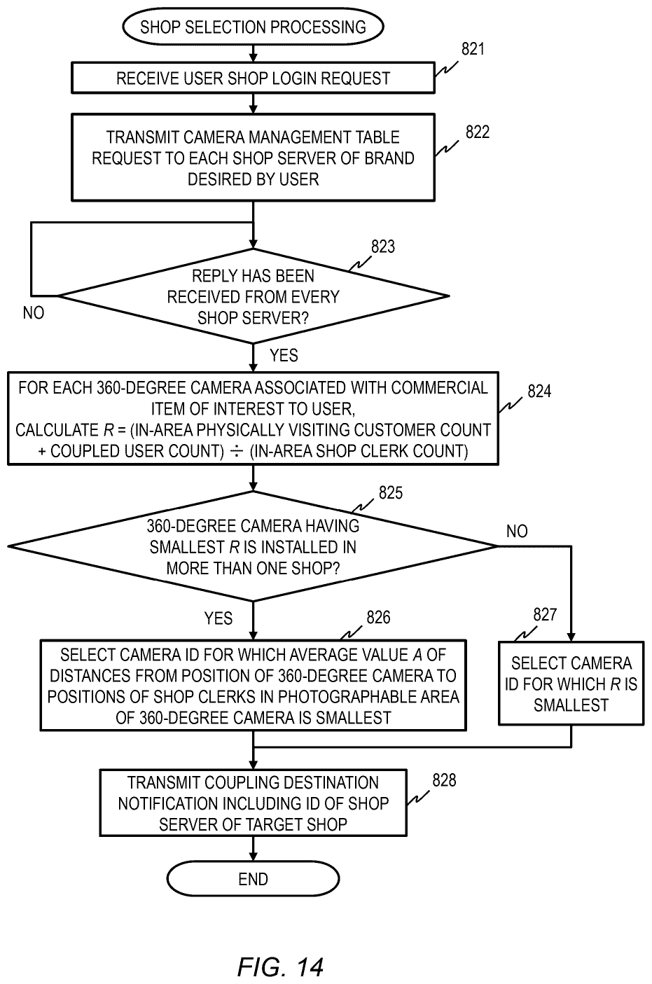

The user terminal 2 transmits a user shop login request to the XR server 1 in accordance with input from the user (405). The user shop login request includes, for example, a user ID and information that indicates a brand desired by the user. When the user shop login request is received, the shop selection module 113 of the XR server 1 executes shop selection processing (406) and, in the shop selection processing, transmits a camera management table request to each shop server 3 of the brand indicated by the user shop login request (407). Details of the shop selection processing are described later with reference to FIG. 14.

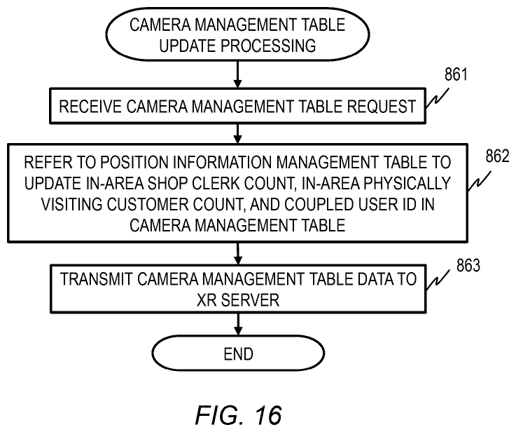

The camera management table update module 312 of each shop server 3 executes camera management table update processing (408). Details of the camera management table update processing are described later with reference to FIG. 16. The camera management table update module 312 of each shop server 3 transmits the position information management table 321, the commercial item type management table 323, and the camera management table 322 updated in Step 408 to the XR server 1 (409).

In the shop selection processing, the shop selection module 113 of the XR server 1 determines the 360-degree camera 5 to which the user terminal 2 is to be coupled, based on information of the received position information management table 321, commercial item type management table 323, and camera management table 322, and transmits, to the user terminal 2, a coupling destination notification which indicates the camera ID of the determined 360-degree camera 5 and one of the shop systems 40 that includes the determined 360-degree camera 5 (410).

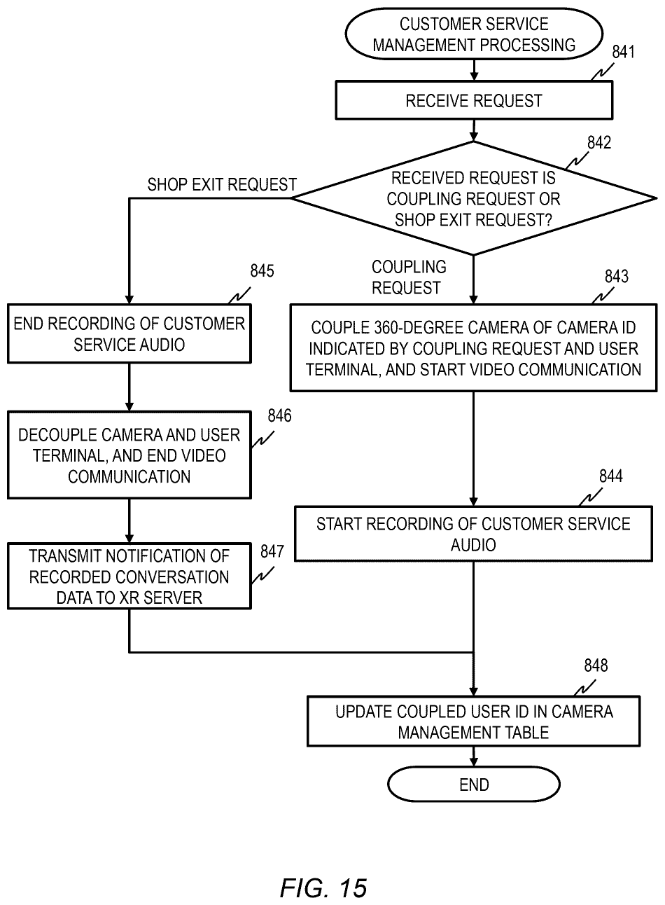

The user terminal 2 transmits, to the shop server 3 included in one of the shop systems 40 that is indicated by the coupling destination notification, a coupling request for requesting coupling to the 360-degree camera 5 that has the camera ID indicated by the coupling destination notification (411). The customer service management module 313 of the shop server 3 that has received the coupling request executes customer service management processing (412). In the customer service management processing, the customer service management module 313 transmits, to the user terminal 2, an OK response that permits coupling to the 360-degree camera 5 that has the camera ID indicated by the coupling request (413), and, when determining that the coupling between the user terminal 2 and the identified 360-degree camera 5 is completed, transmits a coupling completion notification to the XR server 1 (414). The coupling completion notification includes, for example, information indicating the user ID and the camera ID of the user terminal 2 and the 360-degree camera 5, respectively, that have completed coupling, and indicating the shop ID of a shop at which the identified 360-degree camera 5 is placed. Details of the customer service management processing are described later with reference to FIG. 15.

When determining, by referring to the camera management table 322, that another user terminal 2 is currently coupled to the 360-degree camera 5 that has the camera ID indicated by the received coupling request, the customer service management module 313 is recommended to suspend start of the processing step of Step 413 and the processing step of Step 414 (that is, sets a coupling waiting state) until coupling between the identified 360-degree camera 5 and the another user terminal 2 ends. In the case of suspending the start of the processing step of Step 413 and the processing step of Step 414, the customer service management module 313 may transmit a standby notification to the user terminal 2 that has transmitted the coupling request of Step 411. The same coupling waiting state and standby notification as here applies to Step 419 and Step 420 described later.

When the coupling completion notification is received, the user management module 112 of the XR server 1 executes the user management processing (415). The real-time video delivery module 311 of the shop server 3 coupled to the 360-degree camera 5 that has completed coupling in Step 414 transmits video and audio acquired by the coupled 360-degree camera 5 to the user terminal 2, and outputs, from the coupled 360-degree camera 5, audio received from the user terminal 2 (416). Remote customer service provided by a shop clerk of the shop at which the shop system 40 is placed to the user of the user terminal 2 is implemented by Step 416.

The user terminal 2 is allowed to transmit, in accordance with input from the user, a coupling request for switching from the 360-degree camera 5 to which the user terminal 2 is currently coupled (to another 360-degree camera 5 in the same shop) to the shop server 3 of the shop (417). The customer service management module 313 of the shop server 3 that has received the coupling request for switching executes the customer service management processing (418). Step 419 to Step 422 are the same as Step 413 to Step 416, respectively.

The user terminal 2 transmits, in accordance with input from the user, a shop exit request to the shop server 3 included in one of the shop systems 40 that includes the 360-degree camera 5 to which the user terminal 2 is currently coupled (423). The customer service management module 313 of the shop server 3 that has received the shop exit request executes the customer service management processing (424) and, in the customer service management processing, transmits a conversation data notification which includes conversation data of a conversation held between the user and the shop clerk in Step 416 and Step 422, and the user ID of the user to the XR server 1 (425).

When the conversation data notification is received, the user management module 112 of the XR server 1 executes the user management processing (426). Step 427 to Step 429 are the same as Step 402 to Step 404, respectively. The user terminal 2 transmits a logout request to the XR server 1 in accordance with input from the user (430). When the logout request is received, the user management module 112 of the XR server 1 executes the user management processing (431) and, in the user management processing, transmits an OK response to the user terminal 2 that has transmitted the logout request (432).

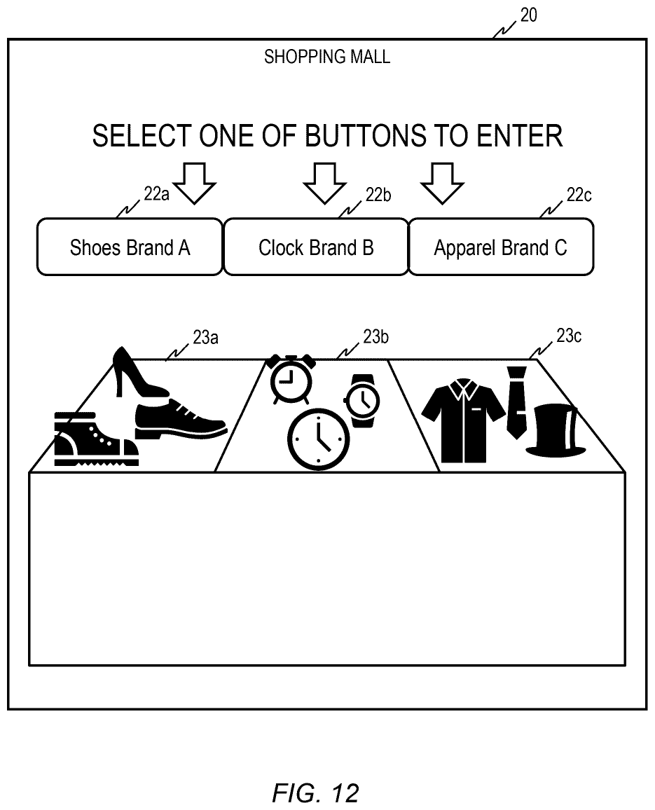

FIG. 12 is a diagram for illustrating a screen configuration example of a shopping mall display screen displayed on each user terminal 2. A shopping mall as a VR space is displayed on a shopping mall display screen 20. For example, buttons 22a to 22c and 3D models 23a to 23c are displayed on the shopping mall display screen 20. When one of the buttons 22a to 22c is selected, a user shop login request indicating a corresponding brand is transmitted to the XR server 1. The 3D models 23a to 23c are 3D models of commercial items of the brands corresponding to the buttons 22a to 22c, respectively.

FIG. 13 is a flow chart for illustrating an example of the user management processing executed in Step 403, Step 415, Step 421, and Step 426. The user management module 112 of the XR server 1 receives a message (801). The user management module 112 determines whether the message received in Step 801 is the shopping mall data request from the user terminal 2 (802). When it is determined that the message received in Step 801 is the shopping mall data request (802: YES), the user management module 112 starts transmission of the shopping mall VR space data 124 to the user terminal 2 that has transmitted the shopping mall data request (803), updates the user management table 121 (804), and ends the user management processing.

When it is determined that the message received in Step 801 is not the shopping mall data request from the user terminal 2 (802: NO), the user management module 112 determines whether the message is the coupling completion notification from the shop server 3 (805). When the user management module 112 determines that the message received in Step 801 is the coupling completion notification (805: YES), the process proceeds to Step 804.

When it is determined that the message received in Step 801 is not the coupling completion notification (805: NO), the user management module 112 determines whether the message is the conversation data notification from the shop server 3 (806). When it is determined that the message received in Step 801 is the conversation data notification (806: YES), the user management module 112 infers a commercial item of interest in which the user is interested from the conversation data included in the received conversation data notification (809), and the process proceeds to Step 804.

In Step 809, the user management module 112 infers the commercial item of interest by, for example, converting the user's audio included in the conversation data (the audio transmitted from the user terminal 2) into text, and performing natural language processing on the text with use of a predetermined algorithm. Specifically, for example, the user management module 112 extracts a word representing a commercial item and a word similar to the commercial item from the text, and determines, as a commercial item of interest, a commercial item corresponding to a word that has a high frequency of appearance in the text under a predetermined condition (for example, a predetermined number of words ranked high in the order of frequency of appearance, or a word having a frequency of appearance equal to or more than a predetermined value). The user management module 112 may also calculate an index indicating, for each commercial item, the user's strength of interest in the commercial item (hereinafter also referred to as “the degree of interest”), and a calculation algorithm is set so that the degree of interest in each commercial item has a higher value when the frequency of appearance is higher. Those processing procedures can save the user the trouble of inputting information that indicates the user's interest in each commercial item.

When it is determined that the message received in Step 801 is not the conversation data notification (806: NO), the user management module 112 determines whether the message is the logout request (810). When it is determined that the message is the logout request (810: YES), the user management module 112 ends transmission of the shopping mall VR space data 124 to the user terminal 2 that has transmitted the logout request (807), and transmits an OK response to the user terminal 2 (808). The process then proceeds to Step S804. When it is determined that the message received in Step 801 is not the logout request (810: NO), the user management module 112 ends the user management processing.

Contents of update in the processing of updating the user management table 121 in Step 804 vary depending on which processing step has been executed immediately before the process proceeds to Step 804. In the case in which the process has proceeded to Step 804 from Step 803, the user management module 112 updates a record of the user management table 121 that holds a user ID associated with the user terminal 2 that has transmitted the shopping mall data request so that the value in the logged-in shop ID field 1212 and the value in the coupling destination camera ID field 1214 are updated to “-(shopping mall)” and “-,” respectively.

In the case in which the message is determined to be the coupling completion notification in Step 805 and the process then proceeds to Step 804, the user management module 112 updates a record of the user management table 121 that holds a user ID indicated by the coupling completion notification so that the value in the logged-in shop ID field 1212 and the value in the coupling destination camera ID field 1214 are updated to a shop ID and a camera ID, respectively, that are indicated by the coupling completion notification.

In the case in which the process has proceeded to Step 804 from Step 809, the user management module 112 updates a record of the user management table 121 that holds a user ID indicated by the conversation data notification so that the value in the commercial-item-of-interest field 1213 is updated to a value indicating the commercial item of interest that has been inferred in Step 809. In the case in which the degree of interest has been calculated in Step 809, the user management module 112 stores, in a record of the user management table 121 that holds the user ID indicated by the conversation data notification, information indicating, for each commercial item, the degree of interest in the commercial item.

In the case in which the process has proceeded to Step 804 from Step 808, the user management module 112 updates a record of the user management table 121 that holds a user ID associated with the user terminal 2 that has transmitted the logout request so that the value in the logged-in shop ID field 1212 and the value in the coupling destination camera ID field 1214 are updated to “-” (that is, a value indicating that the user is not logged in to any shop let alone the shopping mall) and “-”, respectively.

FIG. 14 is a flow chart for illustrating an example of the shop selection processing executed in Step 406. The shop selection module 113 of the XR server 1 receives the user shop login request from the user terminal 2 (821). The shop selection module 113 identifies, from the shop management table 123, shop IDs of a brand desired by a user that is indicated by the user shop login request, and transmits the camera management table request to each shop server 3 included in one of the shop systems 40 that is associated with the identified shop ID (822).

The shop selection module 113 determines whether a reply (including the position information management table 321, the commercial item type management table 323, and the camera management table 322 updated in the camera management table update processing) has been received from every shop server 3 that has received the camera management table request (823). When it is determined that the reply has not been received from at least one shop server 3 out of the shop servers 3 that have received the camera management table request (823: NO), the shop selection module 113 continues to wait for reception of the reply.

When it is determined that the reply has been received from every shop server 3 that has received the camera management table request (823: YES), the shop selection module 113 identifies, from the user management table 121, each commercial item of interest associated with the user ID of the user terminal 2 that has transmitted the user shop login request, identifies, from the commercial item type management table 323 included in the reply, a camera ID that is associated with the identified commercial item of interest, and calculates an index R for each 360-degree camera 5 that has the identified camera ID (824). Commercial items of interest may be specified by input from the user of the user terminal 2.

The shop selection module 113 calculates R for each 360-degree camera 5 by “R=(in-area physically visiting customer count+coupled user count)÷(in-area shop clerk count)” with reference to the camera management table 322 that includes the camera ID of the 360-degree camera 5. In a case in which the in-area shop clerk count is 0, the shop selection module 113 is recommended to determine R to be a constant M (M is an extremely large value which is too large to be taken by R in normal circumstances). The sum of the in-area physically visiting customer count and the coupled user count indicates the degree of congestion of customers in the photographable area of the relevant camera.

The shop selection module 113 determines whether the 360-degree camera 5 for which R calculated in Step 824 is minimum is installed in more than one shop (825). When it is determined that the 360-degree camera 5 that has a minimum value for R is installed in only one shop (825: NO), the shop selection module 113 selects the camera ID of the 360-degree camera 5 that has a minimum value for R (827), transmits the coupling destination notification indicating the selected camera ID and which one of the shop systems 40 includes the 360-degree camera 5 having the selected camera ID to the user terminal 2 (828), and ends the shop selection processing.

When it is determined that the 360-degree camera 5 that has a minimum value for R is installed in more than one shop (825: YES), the shop selection module 113 calculates, for each 360-degree camera 5 that has a minimum value for R, an average value A of distances from the position of the 360-degree camera 5 to respective positions of shop clerks present in the photographable area of the 360-degree camera 5, and selects a camera ID for which the calculated average value A is smallest (826). The process then proceeds to Step 828. The shop selection module 113 identifies respective positions of shop clerks present in the photographable area of the 360-degree camera 5 from the position information management table 321 and the camera management table 322, and identifies the position of the 360-degree camera 5 from the position information management table 321.

In the example described above, when R is smaller, the number of customers (physically visiting customers and remote users) who may require customer service is small relative to the number of shop clerks in the area. Accordingly, when the user terminal 2 of a user is coupled to the 360-degree camera 5 that has a small value for R, it is highly likely that a shop clerk is available to promptly start providing remote customer service to the user and, in addition, physically visiting customers in the area can readily be attended to, which means, on the shop's side, that making full use of available shop clerks is achieved.

In the example described above, when A is smaller, more shop clerks are present near the 360-degree camera 5. Accordingly, when the user terminal 2 of a user is coupled to the 360-degree camera 5 that has a small value for A, it is particularly highly likely that a shop clerk is available to promptly start providing remote customer service to the user and, in addition, physically visiting customers in the area can readily be attended to, which means, on the shop's side, that making full use of available shop clerks is achieved.

The calculations of R and A described above takes not only simple distances but also the photographable area of the 360-degree camera 5 into consideration, to thereby achieve selection of the 360-degree camera 5 around which a shop clerk available to promptly start providing remote customer service to a user is highly likely to be present, with a situation about, among others, the presence or absence of an obstacle such as a shelf taken into consideration.

When it is determined in Step 824 that the in-area shop clerk count is 0 with respect to every one of the 360-degree cameras 5 that are associated with the user's commercial items of interest, the shop selection module 113 may select a camera ID associated with a 360-degree camera that has the smallest value as a value obtained by dividing a total count of physically visiting customers in the shop at which the 360-degree cameras 5 are installed by a total count of the shop clerks in the shop, or may select a camera ID at random from among the camera IDs of the 360-degree cameras 5 that are associated with the user's commercial items of interest, or may select a camera ID in accordance with input from the user by presenting a list of the 360-degree cameras 5 that are associated with the user's commercial items of interest on the user terminal 2.

Although the shop selection module 113 in the example described above selects only from the 360-degree cameras 5 that are associated with the user's commercial items of interest, selection of the 360-degree camera 5 may take the degree of interest described above into consideration. Specifically, for example, the shop selection module 113 calculates R for each of the 360-degree cameras 5 of all camera IDs that are included in the commercial item type management table 323 included in the reply, acquires the degree of interest in each commercial item associated with the user ID of the user terminal 2 that has transmitted the user shop login request, and calculates, in place of R of the processing step of Step 824 described above, a product of R of each of the 360-degree cameras 5 and the degree of interest in a commercial item associated with the 360-degree camera 5 in the commercial item type management table 323 (may be a weighted sum weighted by a predetermined weight, or the like). This enables selection of the 360-degree camera 5 that satisfies both of the user's interest and availability of remote customer service.

FIG. 15 is a flow chart for illustrating an example of the customer service management processing in Step 412, Step 418, and Step 424. The customer service management module 313 of the shop server 3 receives a request from the user terminal 2 (841). The customer service management module 313 determines whether the request received in Step 841 is the coupling request or the shop exit request (842).

When it is determined that the request received in Step 841 is the coupling request (842: coupling request), the customer service management module 313 couples the 360-degree camera 5 that has a camera ID indicated by the coupling request and the user terminal 2 that has transmitted the coupling request, and instructs the real-time video delivery module 311 to start video communication (communication of video and audio) (843). The customer service management module 313 starts recording of audio (customer service audio) in the video communication between the 360-degree camera 5 and the user terminal 2 coupled in Step 843 which are the 360-degree camera 5 having the indicated camera ID and the user terminal 2 that has transmitted the coupling request (844). The camera management table update module 312 updates a value in the coupled user ID field 3228 in the camera management table 322 that is associated with the indicated camera ID (848), and the customer service management processing is then ended.

When it is determined that the request received in Step 841 is the shop exit request (842: shop exit request), the customer service management module 313 ends recording of the customer service audio of the user terminal 2 that has transmitted the shop exit request and the 360-degree camera 5 for which a user terminal ID associated with the user terminal 2 is included as a coupled user ID in the camera management table 322 (845). The customer service management module 313 instructs the real-time video delivery module 311 to end the video communication between the user terminal 2 and the 360-degree camera 5 (846). The customer service management module 313 transmits the conversation data notification including the recorded customer service audio to the XR server 1 (847). The process then proceeds to Step 848.

FIG. 16 is a flow chart for illustrating an example of the camera management table update processing in Step 408. The camera management table update module 312 receives a camera management table request from the XR server 1 (861). The camera management table update module 312 refers to the position information management table 321 which is kept updated by the position information management table update module 314 to update values of the camera management table 322 in the in-area shop clerk count field 3226, the in-area physically visiting customer count field 3227, and the coupled user ID field 3228 (862). The camera management table update module 312 transmits the camera management table 322 updated in Step 862 to the XR server 1 (863), and ends the camera management table update processing.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings show control lines and information lines as considered necessary for explanations but do not show all control lines or information lines in the products. It can be considered that almost of all components are actually interconnected.

What is claimed is:

1. A remote customer service system, comprising:
a server; and
one or more cameras that are placed in each of a plurality of shops and that are couplable to user terminals,
the server being configured to:
hold camera management information indicating the number of shop clerks included in a photographable area of each of the one or more cameras, the number of physically visiting customers in the photographable area, and the user terminals that are respectively coupled at present to the one or more cameras;
receive a shop login request from a first user terminal;
calculate, for each of the one or more cameras, an index value based on a degree of congestion of customers and on the number of shop clerks included in the photographable area, the degree of congestion being based on the number of the physically visiting customers who are included in the photographable area and the number of the user terminals that are coupled at present; and
select, based on the index value, one of the one or more cameras that is to be coupled to the first user terminal, and
wherein remote communication is executed between the first user terminal and the selected one of the one or more cameras.

2. The remote customer service system according to claim 1, wherein the index value is a value obtained by dividing a sum of the number of the physically visiting customers who are included in the photographable area and the number of the user terminals that are coupled at present by the number of the shop clerks included in the photographable area.

3. The remote customer service system according to claim 1, wherein the server is configured to:
hold position management information indicating a position of each of the one or more cameras and respective positions of the shop clerks;
calculate, for each of the one or more cameras, an average value of distances from the position of the each of the one or more cameras to the respective positions of the shop clerks included in the photographable area; and
select, based on the index value and the average value, one of the one or more cameras that is to be coupled to the first user terminal.

4. The remote customer service system according to claim 1, wherein the server is configured to:
hold:
user management information including information indicating interest of a user of each of the user terminals in a commercial item; and
commercial item management information indicating, for each of the one or more cameras, a commercial item photographable by the each of the one or more cameras; and
select one of the one or more cameras that is to be coupled to the first user terminal, based on the information that is included in the user management information and that indicates the interest, on the commercial items photographable by the one or more cameras, and on the index value.

5. The remote customer service system according to claim 4,
wherein the user management information indicates a commercial item of interest in which the user is interested, and
wherein the server is configured to:
identify, by referring to the user management information and the commercial item management information, cameras that are ready to photograph the commercial item of interest out of the one or more cameras; and
select one of the one or more cameras that is to be coupled to the first user terminal, from among the identified cameras, based on the index value.

6. The remote customer service system according to claim 4,
wherein the user management information holds, for each commercial item, a degree of interest indicating strength of interest held by the user in the each commercial item, and
wherein the server is configured to select one of the one or more cameras that is to be coupled to the first user terminal, based on the index value and on the degree of interest in each of commercial items photographable by the one or more cameras.

7. The remote customer service system according to claim 4, wherein the server is configured to:
acquire conversation data in the remote communication executed between the first user terminal and the selected one of the one or more cameras;
generate, based on frequencies of appearance of commercial items in the conversation data, information indicating, for each commercial item, the interest of a user of the first user terminal in the each commercial item; and
store the generated information indicating the interest in the user management information.

8. The remote customer service system according to claim 1, further comprising the first user terminal,
wherein the first user terminal includes an input device, and
wherein the first user terminal is configured to:
receive, via input to the input device, selection of another camera in video that is displayed on the first user terminal and that is photographed by one of the one or more cameras that is currently coupled to the first user terminal; and
switch from the one of the one or more cameras that is currently coupled to the first user terminal to the another camera.

9. An information processing device, comprising:
a processor; and a memory,
the memory holding camera management information indicating the number of shop clerks included in a photographable area of each of the one or more cameras that are placed in each of a plurality of shops and that are couplable to user terminals, the number of physically visiting customers in the photographable area, and the user terminals that are respectively coupled at present to the one or more cameras, and
the processor being configured to;
receive a shop login request from a first user terminal;
calculate, for each of the one or more cameras, an index value based on a degree of congestion of customers and on the number of shop clerks included in the photographable area, the degree of congestion being based on the number of the physically visiting customers who are included in the photographable area and the number of the user terminals that are coupled at present; and
select, based on the index value, one of the one or more cameras that is to be coupled to the first user terminal for remote communication between the first user terminal and the selected one of the one or more cameras.

10. A remote customer service method by a remote customer service system, the remote customer service system including:
a server; and
one or more cameras that are placed in each of a plurality of shops and that are couplable to user terminals,
the server holding camera management information indicating the number of shop clerks included in a photographable area of each of the one or more cameras, the number of physically visiting customers in the photographable area, and the user terminals that are respectively coupled at present to the one or more cameras;
the remote customer service method comprising:
receiving, by the server, a shop login request from a first user terminal;
calculating, by the server, for each of the one or more cameras, an index value based on a degree of congestion of customers and on the number of shop clerks included in the photographable area, the degree of congestion being based on the number of the physically visiting customers who are included in the photographable area and the number of the user terminals that are coupled at present; and
selecting, by the server, based on the index value, one of the one or more cameras that is to be coupled to the first user terminal, and
wherein remote communication is executed between the first user terminal and the selected one of the one or more cameras.
